(19) United States
(12) Patent Application Publication
(10) Pub. No.: US 2011/0159225 A1
(43) Pub. Date: Jun. 30, 2011

(54) High Performance Foam Adhesive Tape

(75) Inventors: James T. Boyle, North Andover, MA (US); Katherine Pelle, Peabody, MA (US)

(73) Assignee: BOSTIK, INC., Wauwatosa, WI (US)

(21) Appl. No.: 12/975,692

(22) Filed: Dec. 22, 2010

Related U.S. Application Data
(60) Provisional application No. 61/291,417, filed on Dec. 31, 2009.

(51) Int. Cl. C09J 7/02; B32B 33/00

(52) U.S. Cl. 428/41.8

(57) ABSTRACT

A conformable, pressure sensitive foam adhesive tape has a closed-cell polyolefin foam core, pressure sensitive adhesive having a polyacrylate backbone with modified silyl functionality, and a coated release liner. The coating on the release liner is a platinum-catalyzed polysiloxane coating.

### FIELD OF THE INVENTION

The invention pertains to conformable, pressure sensitive foam adhesive tape, and in particular high performance, pressure sensitive foam adhesive tape utilizing a closed cell, polyolefin foam core.

### BACKGROUND

Double-sided closed-cell foam adhesive tapes with very high bond strength are used in a number of applications such as bonding automotive weather stripping, name plates, decorative trim, etc. Double-sided, closed-cell foam adhesive tapes provide the capability of conforming to irregularities of mating rigid surfaces even when there might be a slight mismatch. In these applications, it is often important that the tape have high peel adhesion e.g., a 180° peel force to stainless steel of greater than 6 or 7 psi with a 15 minute dwell time when tested according to PSTC #101, procedure A. It is also commercially important that the foam adhesive perform well for a relatively large variety of surface materials and that it be water and solvent resistant.

Commercially available high performance, pressure sensitive foam adhesive tapes typically utilize a closed-cell, acrylic foam core and high bond strength, pressure sensitive acrylic adhesive coated onto the acrylic foam core. The commercial product is normally provided in a roll with a polyolefin release liner covering the acrylic adhesive layer on one side of the acrylic foam core and separating adjacent adhesive layers in the roll. While the performance of pressure sensitive, acrylic foam adhesive tape is typically very good, acrylic foam tapes tend to be relatively expensive.

One of the objects of the present invention is to provide a pressure sensitive adhesive foam tape having a closed-cell polyolefin foam core and pressure sensitive adhesive with high bond strength to a wide range of substrate materials.

### SUMMARY

The invention is directed to a foam adhesive tape having a closed-cell polyolefin foam core, pressure sensitive adhesive having a polyacrylate backbone and modified silyl functionality, and a polysiloxane coated release liner. Pressure sensitive adhesives with a polyacrylate backbone and modified silyl functionality are commercially available and are known in the art to exhibit high bond strength to a wide variety of surface materials. However, it has been found that pressure sensitive adhesive with a polyacrylate backbone and modified silyl functionality reacts with common silicone release liners, and forms an undesirable bond with such release liners. In accordance with the invention, the coating on the release liner consists essentially of platinum-catalyzed polymeric polysiloxane. It has been discovered that the platinum-catalyzed polysiloxane coating does not react with pressure sensitive adhesive having a polyacrylate backbone and modified silyl functionality, and does not compromise tape performance or shelf life.

The preferred foam core is an extruded, radiation cured polyethylene foam core, although polypropylene or polyolefin blends may be used as long as the foam meets the performance criteria for the specified application. For example, in an exemplary embodiment of the invention, the foam core has a density in the range of 300-800 kg/m3, a tensile strength in the range of 400-600 psi, a thickness in the range of 0.66-0.86 mm and elongation in the range of 400-600%. The polyolefin foam core should contain no low molecular weight species such as slip agents, waxes, oils or stearates which are often used as processing aids for extrusion manufacturing. It has been discovered that the silyl-modified polyacrylate adhesive attracts low molecular weight species if they are present in the polyolefin foam, causing the low molecular weight species to migrate into the adhesive. Such migration degrades adhesive performance. Therefore, it is desired that the polyolefin foam core contain no low molecular weight species.

It is also preferred that the release coating not be formulated with control release agents that are typically used in the art. The use of such release agents on the release liner has also been shown to compromise adhesive performance.

As mentioned, the pressure sensitive adhesive is a silyl modified polyacrylate. The preferred adhesive composition is: 94.75 parts base polymer (74.9% 2-Ethylhexyl Acrylate, 7% Isobornyl Acrylate, 15% Methyl Acrylate, 3% Acrylic Acid, 0.1% Methacroyloxypropyltrimethoxy Silane) 0.125 parts aluminum acetylacetonate and 5 parts silyl-terminated polypropylene oxide. It has been found that adhesive foam tape constructed in accordance with the invention provides significant tack and peel strengths, e.g., greater than 7 psi force utilizing PSTC #101, procedure A with 15 minute dwell time (180 degree peel test to stainless steel at room temperature); and, also high performance shear adhesion, e.g., infinite shear strength on stainless steel at 10 psi under PSTC #107, procedure A and greater than 2,000 minutes shear strength at 20 psi. The adhesive foam tape is also solvent and UV resistant.

It is contemplated that the invention will be implemented primarily with the pressure sensitive adhesive laminated to both sides of the closed cell polyolefin foam core; although single sided embodiments are also contemplated. Double sided tape will normally be provided in a roll form, and in such a case the release liner has a platinum-catalyzed polymeric polysiloxane coating on both sides of the liner. To use the tape, it is unrolled and the open adhesive surface of the foam tape is placed on the primary surface with pressure to ensure 100% contact. This can be done for example with a roller. Then the release liner is removed and the clean secondary surface is applied to the exposed pressure sensitive adhesive on the foam tape with firm even pressure to ensure complete contact of the mating parts. The mechanical nature of the foam allows the foam to distort and accommodate structural inconsistencies between the mating surfaces.

In another aspect, the invention is directed to a method of making the above-described pressure sensitive, polyolefin foam adhesive tape. The first step in the process pertains to coating the release liner. The base film for the release liner is preferably a polyolefin film, and more preferably a polypropylene film, although other types of materials (e.g., paper) may be used for the base film of the release liner depending on the specific application for the tape. A solution of platinum-catalyzed polymeric polysiloxane is thermally cured on one or both sides of the base film of the release liner, depending on whether one side or both sides of the release liner will interface with the pressure sensitive adhesive. Silyl-modified polyacrylate pressure sensitive adhesive is applied to the coated release liner in liquid form using for example a film line coating head. The adhesive is a solvent based adhesive. Solvent removal is accomplished by passing the liquid adhesive coated release liner through a series of heated zones with controlled air flow at appropriate temperatures. This step in the process results in an even layer of solid pressure sensitive adhesive on the coating of platinum-catalyzed polymeric polysiloxane on one side of the release liner. Next, a lamination process brings together the adhesive coated release liner and one side of the polyolefin closed-cell foam core to form a first pass laminate. As mentioned, the polyolefin foam core should contain no low molecular weights species such as slip agents or stearates or waxes or oils. Prior to lamination, the surface energy of the polyolefin foam core must be in excess of about 56 dynes/cm2 in order to ensure good anchoring between the foam and the adhesive upon lamination. Achieving sufficient surface energy would normally be achieved by treating the polyolefin foam core in line via corona discharge treatment. For single-sided adhesive foam tape the above explained process is sufficient to complete manufacture of the final product. In order to manufacture double-sided adhesive foam tape, a second pass intermediate is created through the use of a sacrificial release liner. The sacrificial release liner would typically be made of paper coated on one side with the platinum-catalyzed polymeric polysiloxane coating. Liquid adhesive is applied on the platinum-catalyzed polymeric polysiloxane coating and solvent removal is accomplished in the same manner as described above resulting in a sacrificial release liner with a platinum-catalyzed polymeric polysiloxane coating and a layer of pressure sensitive adhesive on the coated surface. Then, as described above, the sacrificial liner is laminated to the exposed foam of the first pass intermediate, again ensuring that the surface energy of the polyolefin foam core is sufficient to ensure good anchoring between the foam skin and the adhesive. With the pressure sensitive adhesive anchored to the foam, the sacrificial release liner is then removed and the adhesive coated foam is wound in a roll with the second pass adhesive on the inside and the polyolefin release liner on the outside.

### BRIEF DESCRIPTION OF THE DRAWINGS

FIG. 1 illustrates a roll of high bond strength, pressure sensitive foam adhesive tape constructed in accordance with the invention.

FIG. 2 is a cross-section taken along line 2-2 in FIG. 1 of high bond strength, pressure sensitive foam adhesive tape constructed in accordance with the first embodiment of the invention.

FIG. 3 is a detailed view of the area designated 3-3 in FIG. 2 specifically illustrating platinum-catalyzed polymeric polysiloxane coatings on the release liner.

FIG. 4 is a cross-sectional view illustrating a first pass intermediate taken during the manufacturing process for the high bond strength, pressure sensitive foam adhesive shown in FIGS. 1-3.

FIG. 5 is a cross-sectional view of the high bond strength, pressure sensitive foam adhesive tape constructed in accordance with another embodiment of the invention in which the adhesive is laminated on only side of the foam core.

FIG. 6 is a detailed view of the area illustrated by line 6-6 in FIG. 5.

### DETAILED DESCRIPTION

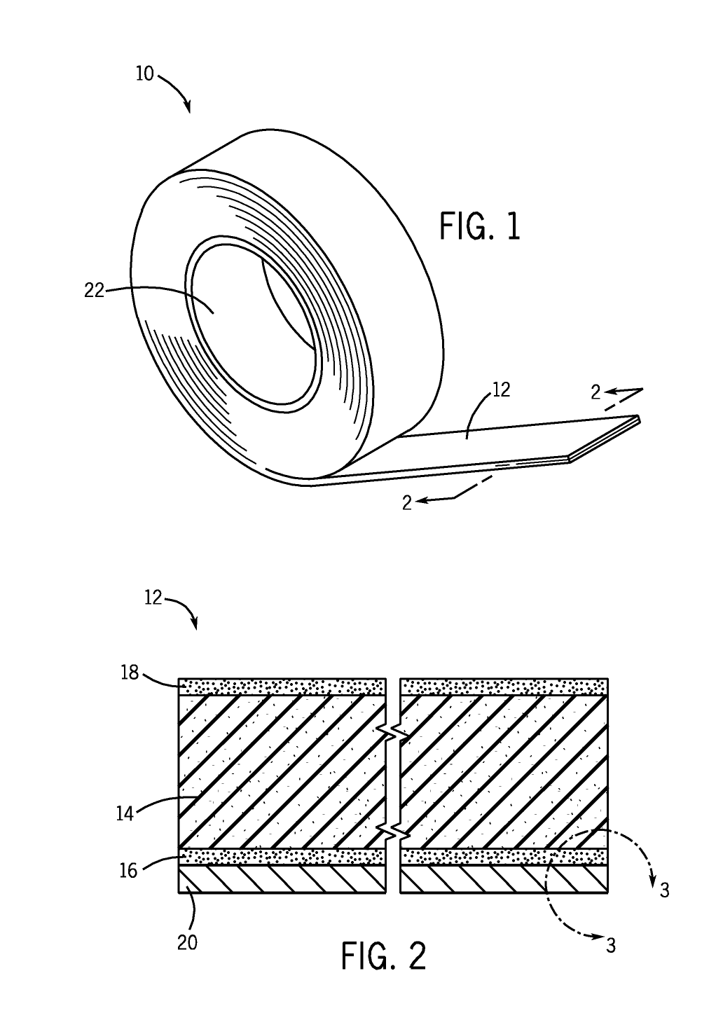

FIG. 1 shows a roll 10 of double-sided, high bond strength, pressure sensitive foam adhesive tape 12 constructed in accordance with a first embodiment of the invention. FIG. 2 shows a cross-section of the tape 12, and in particular illustrates that the tape 12 includes a closed-cell polyolefin foam core 14 and pressure sensitive adhesive 16, 18 on both sides of the foam core 14. A release liner 20 covers the adhesive 16 on one side of the foam core 14. When the pressure sensitive adhesive tape 12 is rolled around a core 22, FIG. 1, the exposed adhesive layer 18 faces inside and the other adhesive layer 16 and release liner 20 faces outside. The release liner 20 separates adjacent layers of adhesive 16, 18 when the adhesive tape 12 is in a roll 10 as shown in FIG. 1. While FIGS. 1-3 show double-sided, pressure sensitive foam adhesive tape 12 in a roll form 10, the invention can also be implemented with the foam adhesive tape in sheet form having a release liner on both sides to cover the adhesive. In addition, the invention can also be implemented with single-sided pressure sensitive foam adhesive tape as depicted in FIGS. 5 and 6, either in roll or sheet form.

As mentioned above, the foam core 14 is a closed-cell polyolefin foam core having an exemplary thickness of 0.71 mm (28 mil) and desirably in the range of 0.66-0.86 mm. The preferred foam core is extruded, radiation cured polyethylene having a density in the range of 300-800 kg/m3. The desired tensile strength is in the range of 400-600 psi and the desired elongation is in the range of 400-600%. Polypropylene or polyolefin blends may be used in place of polyethylene as long as the performance criteria meet the specifications for a given application. In order to use the polyolefin foam core in accordance with the invention, the foam core 14 should contain no low molecular weights species such as slip agents, waxes, oil or stearates. It is particularly desirable that additives such as calcium stearate or zinc stearate be removed from the polyolefin foam 14 and not used during the manufacture of the foam. The reason as mentioned above is that the preferred pressure sensitive adhesive 16, 18, namely silyl modified polyacrylate adhesive, when in contact with the polyolefin foam will cause such low molecular weight species to migrate and absorb into the adhesive if they are present in the polyolefin foam. Such migration and absorption will degrade adhesive performance.

The adhesive 16, 18 is an acrylic adhesive having a polyacrylate backbone with modified silyl functionality. The preferred adhesive is a 50%-50% mixture of adhesives sold under the trade names Avery S8755 and Avery 8631P, supplied from Avery Dennison. These adhesives are known to provide high adhesion and cohesion, low temperature flexibility, relatively low surface energy adhesion, and high temperature resistance. The composition of the polyacrylate base polymer for both adhesives is:

74.9% 2-ethylhexyl acrylate;

7% isobornyl acrylate;

3% acrylic acid;

15% methyl acrylate (compatibilization monomer);

0.1% methacroyloxypropyltrimethoxy silane (cross-linking monomer).

Silyl terminated polypropylene oxide, sold under the trade name SAX-725 by Kaneka, is mixed with the polyacrylate base polymer. The silyl terminated polypropylene oxide has a non-polar backbone and is telechelic in silane functionality. The Avery S8755 adhesive also includes aluminum acetylacetonate which serves as a cross-linker (94.75 parts base polyacrylate polymer; 0.25 parts aluminum acetylacetonate), but the Avery 8631P adhesive does not contain aluminum acetylacetonate. The mixture of adhesives lowers the molecular weight distribution as compared to the use of Avery S8755 and improves peel and shear strength. The polyacrylate base polymer is mixed with the silyl terminated polypropylene oxide polymer preferably in the following proportions:

94.875 parts polyacrylate base polymer;

5 parts silyl terminated polypropylene oxide; and

0.125 parts aluminum acetylacetonate (which serves as a cross-linker).

In the exemplary embodiment, the adhesive 16, 18 layers are deposited at a thickness sufficient to achieve 80±10 g/m2 upon solvent removal. Such polyolefin foam tape with the silyl modified polyacrylate pressure sensitive adhesive 16, 18 provides an excellent balance of high tack and peel strength. The tape has high peel adhesion and cohesion, i.e., a 180° peel force to stainless steel according to PSTC #101, procedure A has tested greater than 7 psi with a 15 minute dwell time. Adhesive shear is infinite on stainless steel at 10 psi under the PSTC #107 standard (procedure A) and greater than 2000 minutes at 20 psi. Polyken probe testing (ASTM D-2979) resulted in greater than 700 grams of force to remove after one second and 925 grams of force to remove after five seconds. The adhesive also provides good temperature resistance in that it permits serviceable bonds in environments from −30° F. to +180° F.

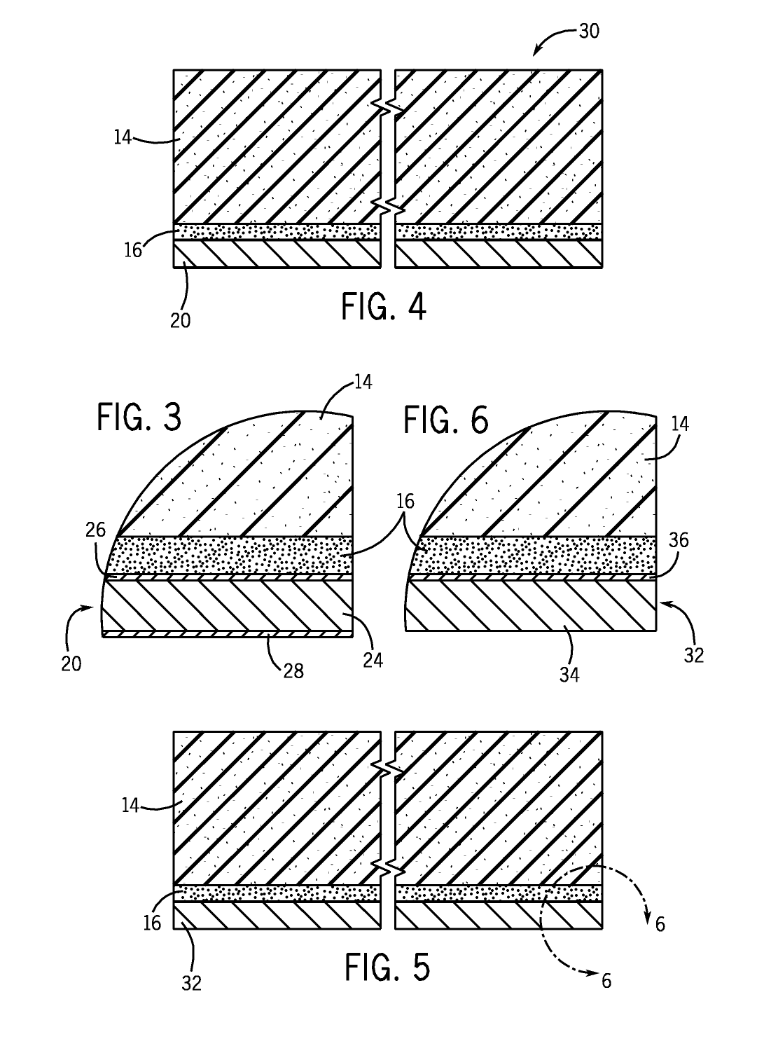

Referring now to FIG. 3, the release liner 20 includes a base film or sheet 24 as well as platinum-catalyzed polymeric polysiloxane coatings 26, 28. The base film 24 is preferably made of polypropylene having a 0.1 mm (4 mil) thickness. Such a film 24 provides sufficient strength which is helpful when applying the tape. However, depending on the specific application, other materials may be suitable for use as the base material 24 for the release liner, such polyethylene, polyolefin blends, metal foils, paper, etc.

In FIG. 3, both sides of the base layer 24 of the release liner 20 are coated with platinum-catalyzed polymeric polysiloxane. The polyolefin release liner 20 is direct coated with thermally cured platinum-catalyzed polymeric polysiloxane, resulting in a coating thickness of approximately 0.013 mm (0.5 mil). Desirably, the platinum-catalyzed polymeric polysiloxane coatings 26, 28 contain no control release agents such as trimethosiloxane, dimethosiloxane, and siloxane. It has been found that such constituents will react with the silyl modified polyacrylate adhesive 16, 18 and compromise adhesive performance.

As mentioned, it has been discovered that the platinum-catalyzed polymeric polysiloxane coating 26, 28 does not react with the adhesive 16, 18 thereby allowing the adhesive to maintain optimum performance and shelf life. Testing has also shown that removing the platinum-catalyst or substituting the catalyst results in an inadequate coating which in turn compromises adhesive performance and shelf life. For example, testing with tin and rhodium catalysts have led to compromised adhesive strength and shelf life. On the other hand, thermally-cured, platinum-catalyzed polysiloxane coatings 26, 28 do not react with the adhesive and do not compromise adhesive performance.

The preferred method of manufacturing the tape involves a multi-step lamination process. FIG. 4 illustrates the first pass laminate 30 in the manufacturing process. The first step involves coating the release liner with the platinum-catalyzed polymeric polysiloxane coating, which is coated on the base film (e.g., polyethylene film) and heat cured. Then, the platinum-catalyzed polymeric polysiloxane coated release liner is passed through a film line coating head to apply the solvent based adhesive on one side of the coated release liner 20. Preferably, as mentioned, the liquid adhesive is deposited in an amount sufficient to achieve 80±10 g/m2 upon solvent removal. A suitable solvent blend is ethyl acetate, isopropanol, methanol, and vinyl acetate. The proportion of adhesive to solvent is not critical, but 50% adhesive to 50% of solvent is suitable. Solvent removal is accomplished by passing the liquid adhesive coated polyolefin release liner 20 through a series of heated zones with controlled air flow. During this process, it is important to not overheat the platinum-catalyzed polymeric polysiloxane coating 26, 28. Heating the coating 26, 28 above 250° F. can cause numerous defects and also lead to loss of low molecular weight species that may compromise adhesive performance. The adhesive 16 on the release liner 20 should have a solvent content of less than 3%. The adhesive coated release liner is then cooled to ambient temperature. This allows for dimensional stability during the subsequent lamination step.

The first lamination step brings together the adhesive coated release liner 20, 16 and the closed-cell polyolefin foam 14. The closed-cell polyolefin film, as mentioned, is manufactured without low molecular weight species (e.g., slip and processing agents) because such low molecular weight species are detrimental to the performance of the adhesive. In particular, it has been discovered that it is particularly important to specifically remove zinc stearate, as well as calcium stearate.

Prior to lamination between nip rollers, the surface energy of the polyolefin foam core 14 must be in excess of about 56 dynes/cm2 in order to ensure sufficient anchoring between the foam skin and the adhesive 16. In its normal state, closed-cell polyethylene foam having the density, tensile strength, thickness and elongation within the ranges described previously will typically have a nominal surface energy between 20-40 dynes/cm2. Therefore, it will likely be necessary to treat the closed-cell polyethylene foam upstream via corona discharge to increase surface energy. Without sufficient surface energy, the adhesive 16 will not anchor to the foam 14 and the product will not perform sufficiently. The first step of the lamination process results in the first pass intermediate 30 shown in FIG. 4. (Note that the release liner 20 in FIG. 4 includes platinum-catalyzed polymeric polysiloxane coatings 26, 28 illustrated in FIG. 3 although they are not specifically shown in FIG. 4).

The second pass intermediate is created using a sacrificial release liner. The sacrificial release liner will normally use a paper base in order to reduce cost, but also includes a thermally-cured, platinum-catalyzed polymeric siloxane coating similar to coating 26 in FIG. 3. It is not necessary to provide a thermally-cured, platinum-catalyzed polymeric polysiloxane coating on the backside of the sacrificial release liner. The coated sacrificial release liner is passed through a film line coating head where it is coated with solvent based liquid adhesive as described above with respect to the first pass intermediate. Again, the solvent is removed by passing the liquid adhesive coated sacrificial release liner through a series of heated zones with controlled air flow, without overheating the platinum-catalyzed polymeric polysiloxane coating. After solvent removal, the sacrificial release liner with the adhesive is cooled to allow for dimensional stability during the second lamination step. As with the first pass intermediate 30, the adhesive on the sacrificial release liner should have a solvent content of less than 3%. The second pass intermediate, namely the sacrificial release liner with an adhesive coating, is then laminated using nip rollers to the uncoated foam 14 of the first pass intermediate 30. As previously discussed, it is important that the surface energy of the foam 14 be in excess of about 56 dynes/cm2 in order to ensure sufficient anchoring between the foam skin 14 and the adhesive 18. The sacrificial release liner is then removed, and the double-sided adhesive coated foam tape 12 is wound with the second pass adhesive on the inside and the polyolefin release liner on the outside.

FIGS. 5 and 6 illustrate another embodiment of the invention in which adhesive 16 is coated on a single side of the polyolefin foam 14. In this case as illustrated in FIG. 6, the release liner 32 includes a base film or sheet 34 as in the prior embodiment but the platinum-catalyzed polymeric polysiloxane coating 36 only needs to be on one side of the release liner 32. This embodiment is preferably manufactured in much the same manner as the first embodiment, except only one lamination step is necessary to anchor the adhesive 16 to the foam core 14.

While the invention has been described with reference to particular embodiments and drawings set forth above, it should be apparent to one skilled in the art that aspects of the invention may be implemented in other embodiments.

What is claimed is:

1. High bond strength, pressure sensitive foam adhesive tape comprising:
a closed cell polyolefin foam core;
pressure sensitive adhesive on at least one side of the polyolefin foam core, the pressure sensitive adhesive having a polyacrylate backbone and modified silyl functionality; and
a coated release liner wherein the coating on the release liner consists essentially of platinum catalyzed polymeric polysiloxane.

2. The high bond strength, pressure sensitive foam adhesive tape as recited in claim 1 wherein the coated release liner comprises a coated sheet of polyolefin material.

3. A high bond strength, pressure sensitive foam adhesive tape as recited in claim 1 wherein the coating on the release liner is thermally cured.

4. A high bond strength, pressure sensitive foam adhesive tape as recited in claim 1 wherein the closed cell polyolefin foam core is an extruded radiation cured polyolefin foam with no low molecular weights species.

5. A high bond strength, pressure sensitive foam adhesive tape as recited in claim 1 wherein the foam has a density in the range of 300 to 800 kg/m³.

6. A high bond strength, pressure sensitive foam adhesive tape as recited in claim 1 wherein the foam has the tensile strength in the range of 400 to 600 psi.

7. A high bond strength, pressure sensitive foam adhesive tape as recited in claim 1 wherein the foam has a thickness in the range 0.66-0.86 mm.

8. A high bond strength, pressure sensitive foam adhesive tape wherein the foam has an elongation of at least 400%.

9. A high bond strength, pressure sensitive foam adhesive tape as recited in claim 1 wherein the platinum catalyzed polymer polysiloxane coating comprises no trimethylsiloxane, dimethylsiloxane or siloxane.

10. A high bond strength, pressure sensitive foam adhesive tape as recited in claim 1 wherein the platinum catalyzed polymer polysiloxane release coating does not contain a control release agent.

11. A high bond strength, pressure sensitive foam adhesive tape as recited in claim 1 wherein the adhesive is characterized as having a 180° peel force greater than 7 psi with a 15 minute dwell time when tested according to PSTC #101, procedure A.

12. A high bond strength, pressure sensitive foam adhesive tape as recited in claim 1 further characterized with infinite shear at 10 psi when tested according to PSTC #107, procedure A.

13. A high bond strength, pressure sensitive foam adhesive tape as recited in claim 1 characterized with shear greater than 2000 minutes at 20 psi when tested in accordance with PSTC #107, procedure A.

14. A high bond strength, pressure sensitive foam adhesive as recited in claim 1 wherein the tape is a double coated adhesive foam tape further comprising:
adhesive on both sides of the closed cell polyolefin foam core, and the adhesive on both sides of the polyolefin foam core having a polyacrylate backbone and modified silyl functionality.

15. A high bond strength, pressure sensitive foam adhesive tape as recited in claim 14 wherein the foam tape is provided in a roll, and the coated release liner includes a coating consisting essentially of a platinum catalyzed polymeric polysiloxane on both sides of the coated release liner.

16. A high bond strength, pressure sensitive foam adhesive as recited in claim 14 further comprising an additional coated release liner, wherein the coating on the additional release liner consists essentially of a platinum catalyzed polymeric polysiloxane, such that one of the respective coated release liners covers adhesive on each side of the polyolefin foam core.
